(19) United States
(12) Patent Application Publication
(10) Pub. No.: US 2016/0381239 A1
(43) Pub. Date: Dec. 29, 2016

(54) IMAGE FORMING APPARATUS, POWER SUPPLY DEVICE, AND IMAGE FORMING METHOD

(71) Applicant: FUJI XEROX CO., LTD., Tokyo (JP)

(72) Inventor: Norio HASEGAWA, Kanagawa (JP)

(21) Appl. No.: 14/943,811

(22) Filed: Nov. 17, 2015

(30) Foreign Application Priority Data
Jun. 26, 2015 (JP) 2015-128362

(51) Int. Cl. H04N 1/00; H01H 47/00

(52) U.S. Cl. CPC H04N 1/00891; H01H 47/00; H04N 2201/0094; H04N 2201/0074

(57) ABSTRACT

An image forming apparatus includes an image forming unit, a power supply switching unit, a switching unit, a switch detecting unit, and a controller. The image forming unit forms an image. The power supply switching unit switches the image forming unit between a power supplied state and a power shut-off state. The switching unit outputs a signal when operated by a user. The switch detecting unit detects the signal output by the switching unit, and transmits a power off signal to the power supply switching unit. The controller receives the signal output by the switching unit, and if normally operating, transmits a signal that invalidates the power off signal or a signal that prevents the transmission of the power off signal.

### CROSS-REFERENCE TO RELATED APPLICATIONS

This application is based on and claims priority under 35 USC 119 from Japanese Patent Application No. 2015-128362 filed Jun. 26, 2015.

### BACKGROUND

Technical Field

The present invention relates to an image forming apparatus, a power supply device, and an image forming method.

Summary

According to an aspect of the invention, there is provided an image forming apparatus including an image forming unit, a power supply switching unit, a switching unit, a switch detecting unit, and a controller. The image forming unit forms an image. The power supply switching unit switches the image forming unit between a power supplied state and a power shut-off state. The switching unit outputs a signal when operated by a user. The switch detecting unit detects the signal output by the switching unit and transmits a power off signal to the power supply switching unit. The controller receives the signal output by the switching unit, and if normally operating, transmits a signal that invalidates the power off signal or a signal that prevents the transmission of the power off signal.

### BRIEF DESCRIPTION OF THE DRAWINGS

An exemplary embodiment of the present invention will be described in detail based on the following figures, wherein:

FIG. 1 is a diagram illustrating an overview of an image forming apparatus of the exemplary embodiment;

FIG. 2 is a diagram illustrating a specific example (first example) of the image forming apparatus illustrated in FIG. 1;

FIG. 3 is a flowchart illustrating an example of a procedure of power supply employed when a power plug of the image forming apparatus is inserted in (connected to) an outlet supplied with a commercial power supply;

FIG. 4 is a flowchart illustrating an example of a procedure of power supply employed when a switch is operated (held down) by a user in a standby mode;

FIG. 5 is a diagram illustrating another specific example (second example) of the image forming apparatus illustrated in FIG. 1; and

FIG. 6 is a diagram illustrating a modified example of the image forming apparatus illustrated in FIG. 2.

### DETAILED DESCRIPTION

An exemplary embodiment of the present invention will be described in detail below with reference to the accompanying drawings. Herein, an image forming apparatus will be described as an example.

### Image Forming Apparatus 100

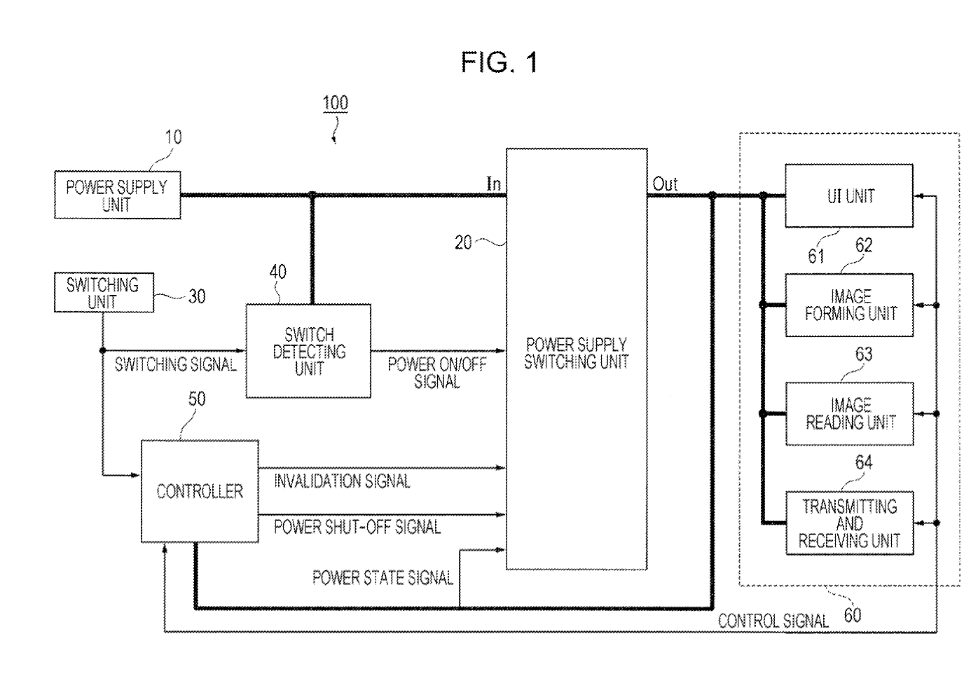

FIG. 1 is a diagram illustrating an overview of an image forming apparatus 100 of the exemplary embodiment. The image forming apparatus 100 is a so-called multifunction machine having a scan function, a print function, a copy function, and a facsimile function.

The image forming apparatus 100 includes a power supply unit 10, a power supply switching unit 20, a switching unit 30, a switch detecting unit 40, a controller 50, and a functional unit 60. The power supply unit 10 is connected to a commercial power supply to supply power. The power supply switching unit 20 switches between supply and shut-off of the power from the power supply unit 10. The switching unit 30 is operated by a user. The switch detecting unit 40 detects the operation of the switching unit 30. The controller 50 controls the image forming apparatus 100 by executing operations and so forth. The functional unit 60 executes functions such as image formation under the control of the controller 50.

The power supply unit 10, the power supply switching unit 20, the switching unit 30, the switch detecting unit 40, and the controller 50 may be described as a power supply device. In this case, the functional unit 60 is a load on the power supply device.

Units such as the power supply unit 10 will first be described.

The power supply unit 10 includes, for example, a rectifier circuit that converts alternating current supplied from the commercial power supply into direct current. For instance, the direct current output from the power supply unit 10 may be a low-voltage current having a voltage of 5 V, for example, and/or a high-voltage current having a voltage of 24 V, for example. A description will be given here on the assumption that the direct current is a low-voltage current having a voltage of 5 V, for example.

The power supply switching unit 20 receives a power on/off signal or a power shut-off signal, which will be described later, and supplies or shuts off the power from the power supply unit 10.

Supplying the power (voltage or current) from the power supply unit 10 may be described here as supply of power (power-on), and stopping the supply of power may be described as shut-off of power (power-off).

The switching unit 30 includes a switch that remains on while the user holds down a button of the switch with a finger and turns off when the user releases the finger from the button, such as a momentary switch, for example. That is, the switching unit 30 is configured of a switch different from an alternate switch that shifts to the on state when pressed by a finger of a user, holds the on state even after release of the finger, and shifts to the off state when pressed again.

The switch detecting unit 40 detects the operation of the switching unit 30 (that the switching unit 30 has been operated), and executes a predetermined process.

The controller 50 includes a processor that executes so-called arithmetic operations and logical operations, and controls the power supply switching unit 20 and the functional unit 60 of the image forming apparatus 100.

The functional unit 60 includes a user interface unit (hereinafter described as UI unit) 61, an image forming unit 62, an image reading unit 63, and a transmitting and receiving unit 64, for example. The UI unit 61 receives an instruction related to an operation using the scan function, the print function, the copy function, or the facsimile function, for example, and displays a message to the user. The image forming unit 62 forms an image on a recording medium such as paper. The image reading unit 63 reads the image recorded on the recording medium such as paper. The transmitting and receiving unit 64 transmits and receives data to and from a terminal apparatus (not illustrated), a facsimile machine (not illustrated), and a server apparatus (not illustrated), which are provided outside the image forming apparatus 100, via a communication line (not illustrated).

The functional unit 60 does not need to include all of the UI unit 61, the image forming unit 62, the image reading unit 63, and the transmitting and receiving unit 64, and may include some of these units.

The functional unit 60 herein refers to parts that control members for realizing functions. For example, the UI unit 61 of the functional unit 60 refers to a part that controls, for example, a display screen equipped with a touch panel, that is, a part that receives a signal from the touch panel and transmits a signal to the controller 50 or receives a signal (command) from the controller 50 and transmits a signal for displaying information on the display screen. The functional unit 60 may include a part other than the part that performs the control.

In the image forming apparatus 100, members controlled by the image reading unit 63 to realize image reading execute the scan function, and members controlled by the image forming unit 62 to realize image formation execute the print function. Further, members controlled by the transmitting and receiving unit 64 to realize transmission and reception execute a communication function, and the members realizing the image reading and the members realizing the image formation execute the copy function. Further, the members realizing the image reading, the members realizing the image formation, and the members realizing the transmission and reception execute the facsimile function.

The connection relationship between units such as the power supply unit 10 will now be described.

In FIG. 1, thick lines indicate power supply lines serving as paths for supplying power. Further, thin arrowed lines indicate signal lines serving as paths of signals. Some of the signal lines are labeled with the names of signals.

The power supply lines will first be described.

The power supply unit 10 is connected to an input terminal of the power supply switching unit 20 (In in FIG. 1) and the switch detecting unit 40 by power supply lines.

When the image forming apparatus 100 is connected to the commercial power supply, therefore, the direct current converted by the power supply unit 10 is supplied to the power supply switching unit 20 and the switch detecting unit 40. That is, when the power plug of the image forming apparatus 100 is inserted in (connected to) the outlet supplied with the commercial power supply, power is supplied to the power supply switching unit 20 and the switch detecting unit 40.

An output terminal of the power supply switching unit (Out in FIG. 1) is connected to the controller 50 and the functional unit 60 by power supply lines. That is, the controller 50 and the functional unit 60 are supplied with power via the power supply switching unit 20.

The signal lines will now be described.

The switching unit 30 is connected to the switch detecting unit 40 and the controller 50 by signal lines for transmitting a switching signal. When the switching unit 30 operates (is operated), the switching signal is transmitted from the switching unit 30 to the switch detecting unit 40 and the controller 50.

Further, the switch detecting unit 40 is connected to the power supply switching unit 20 by a signal line for transmitting the power on/off signal.

Further, the controller 50 is connected to the power supply switching unit 20 by a signal line for transmitting an invalidation signal that invalidates the power off signal and a signal line for transmitting the power shut-off signal.

If the controller 50 is in a normal operating state, the controller 50 transmits the invalidation signal to the power supply switching unit 20 upon receipt of the switching signal indicating that the switching unit 30 has been operated. Then, if a stopping process (shutdown process) is normally completed, the controller 50 transmits the power shut-off signal to the power supply switching unit 20. The invalidation signal and the power shut-off signal will be described later.

Further, a signal line for transmitting a power state signal connects the power supply switching unit 20 to the power supply line connected between the output terminal (Out) of the power supply switching unit 20 and the controller 50. The power state signal indicates whether or not power is supplied from the output terminal (Out) of the power supply switching unit 20.

Further, the controller 50 and the functional unit 60 are connected to each other by a signal line for transmitting and receiving a control signal. On the signal line, a signal (command) for controlling the functional unit 60 is transmitted from the controller 50 to the functional unit 60, and a signal representing a response from the functional unit 60 or a state of the functional unit 60 is transmitted from the functional unit 60 to the controller 50. Each of these signals is herein described as the control signal.

As described above, in the image forming apparatus 100 of the exemplary embodiment, the controller 50 controls the power supply switching unit 20 and the functional unit 60. That is, the controller 50 controls the entire image forming apparatus 100. This configuration obviates the need to provide plural controllers (processors, for example), thereby reducing costs.

### FIRST EXAMPLE

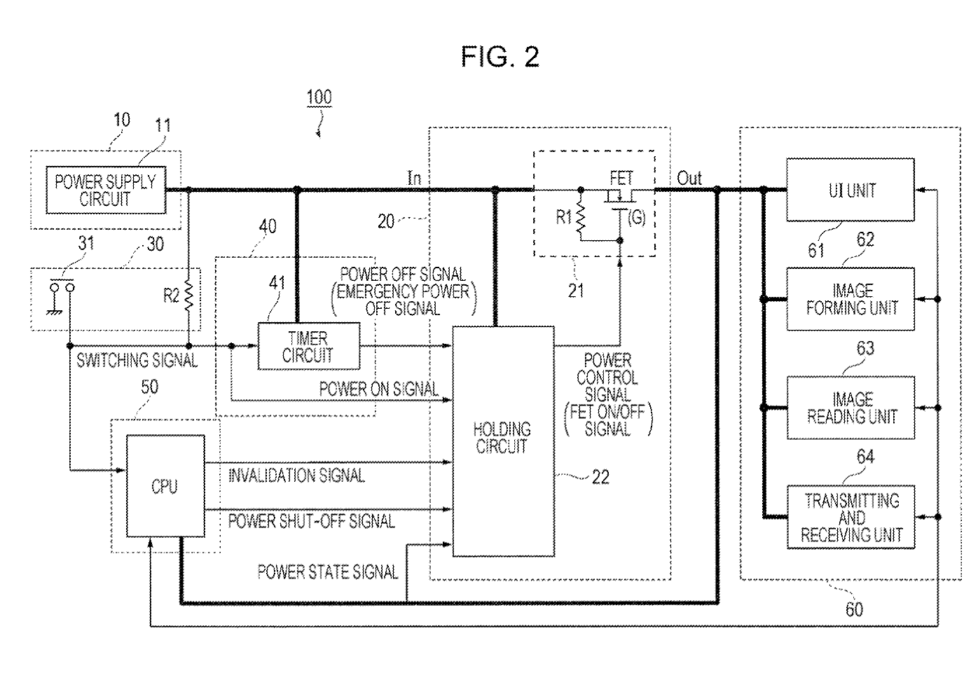

FIG. 2 is a diagram illustrating a specific example (first example) of the image forming apparatus 100 illustrated in FIG. 1. Herein, the power supply unit 10 in FIG. 1 is configured of a power supply circuit 11. The power supply switching unit 20 is configured of a holding circuit 22 and a power supply switching circuit 21 configured of a field-effect transistor (FET) and a resistor R1.

Further, the switching unit 30 is configured of a momentary switch 31 and a resistor R2. The switch detecting unit 40 includes a timing circuit (timer circuit) 41. The controller 50 is configured of a central processing unit (CPU), which is a processor.

In the power supply switching circuit 21 of the power supply switching unit 20, a gate (G) of the FET and the holding circuit 22 are connected to each other by a signal line for transmitting a power control signal (FET on/off signal).

When the FET on signal for turning on the FET is output from the holding circuit 22 to the gate of the FET, the FET is turned on, and power is supplied from the power supply circuit 11 to the functional unit 60 and the CPU of the controller 50.

Meanwhile, if the FET off signal for turning off the FET is output from the holding circuit 22 to the gate of the FET, the FET is turned off, and the power from the power supply circuit 11 to the functional unit 60 and the CPU of the controller 50 is shut off (cut off) (powered off).

For example, the FET on signal corresponds to a power supply potential supplied by the power supply circuit 11 (“H” level), and the FET off signal corresponds to a reference potential (ground (GND) or “L” level).

The resistor R1 is a bias resistor that maintains the off state of the FET.

The holding circuit 22 is a circuit has a latching function similar to that of a delay (D)-type flip-flop circuit, for example, and holds (stores) the potential of the gate of the FET. That is, once the holding circuit 22 starts outputting the FET on signal, the holding circuit 22 continues to output the FET on signal until receipt of an instruction to output the FET off signal. Similarly, once the holding circuit 22 starts outputting the FET off signal, the holding circuit 22 continues to output the FET off signal until receipt of an instruction to output the FET on signal.

The holding circuit 22 may be configured of an integrated circuit (IC) having a latching function, such as a D-type flip-flop circuit, or may be configured of separate transistors or the like. It is assumed here that the holding circuit 22 is configured of separate transistors or the like.

The switch 31 has one terminal set to the reference potential (ground (GND) or “L” level) and the other terminal connected to the power supply potential (“H” level) supplied by the power supply circuit 11 via the resistor R2.

If the momentary switch 31 is not held down, therefore, the switching signal output from the switch 31 is at the “H” level. If the switch 31 is held down, the switching signal is at the “L” level. If the switch 31 is released, the switching signal returns to the “H” level.

In the switch detecting unit 40, the signal line for transmitting the switching signal from the switching unit 30 is divided into two signal lines, one of which is connected to the timer circuit 41 and the other of which is connected to the holding circuit 22 without routing through the timer circuit 41 (detouring around the timer circuit 41). Further, the timer circuit 41 is connected to the holding circuit 22 by a signal line for transmitting the power off signal. On the signal line connected to the holding circuit 22 without routing through the timer circuit 41 (detouring around the timer circuit 41), the switching signal is transmitted as the power on signal.

The timer circuit 41 detects (counts) the period in which the switching signal is at the “L” level. If a predetermined period elapses (if the count reaches a predetermined count value), the timer circuit 41 transmits the power off signal to the holding circuit 22 of the power supply switching unit 20. In other words, the period in which the switching signal is at the “L” level corresponds to the period in which the user holds down the switch 31.

As described later, the power off signal transmitted by the timer circuit 41 is transmitted in case of emergency, such as when the CPU is not operating, and thus may be described as an emergency power off signal.

If the switching signal turns to the “L” level when the power is not supplied from the power supply switching unit 20 to the CPU of the controller 50 and the functional unit 60, the switching signal is transmitted to the holding circuit 22 as the power on signal. The holding circuit 22 detects from the received power state signal that the power from the power supply switching unit 20 to the CPU of the controller 50 and the functional unit 60 is not supplied (the power is shut off). In this case, the holding circuit 22 is transmitting the FET off signal, and thus is capable of detecting, based on the FET off signal being output, that the power from the power supply switching unit 20 to the CPU of the controller 50 and the functional unit 60 is not supplied (the power is shut off).

### Operation of Image Forming Apparatus 100

A description will be given here of an operation of the image forming apparatus 100, focusing on the supply of power. With reference to FIG. 2, a description will first be given of a procedure of power supply employed when the power plug of the image forming apparatus 100 is inserted in (connected to) the outlet supplied with the commercial power supply.

It is assumed here that the image forming apparatus 100 has at least two power supply modes; a standby mode (standby state) and a plugin off mode (plugin off state). The image forming apparatus 100 may also have an energy saving mode, for example.

The standby mode refers to that the image forming apparatus 100 illustrated in FIG. 2 is in a prepared state (standby state) in which functions such as image formation are executable, with the FET of the power supply switching circuit 21 of the power supply switching unit 20 turned on and the power supplied to the power supply switching unit 20, the switching unit 30, the switch detecting unit 40, the controller 50, and the functional unit 60.

Meanwhile, the plugin off mode refers to that the image forming apparatus 100 illustrated in FIG. 2 is in a state in which the FET of the power supply switching circuit 21 of the power supply switching unit 20 is off and the power is supplied to the power supply switching unit 20, the switching unit 30, and the switch detecting unit 40 but not to the controller 50 and the functional unit 60.

The image forming apparatus 100 is not equipped with a switch for interrupting the commercial power supply (a power switch). In the plugin off mode, in which the power plug of the image forming apparatus 100 is inserted in the outlet supplied with the commercial power supply, therefore, the image forming apparatus 100 is in a power shut-off (power-off) state.

The energy saving mode refers to the state in which a function of receiving an operation performed on the touch panel by the user with the UI unit 61 and/or a function of receiving communication with the transmitting and receiving unit 64, for example, is/are maintained in an operating state and the other functions are stopped. In the energy saving mode, less power (energy) is consumed than in the standby mode.

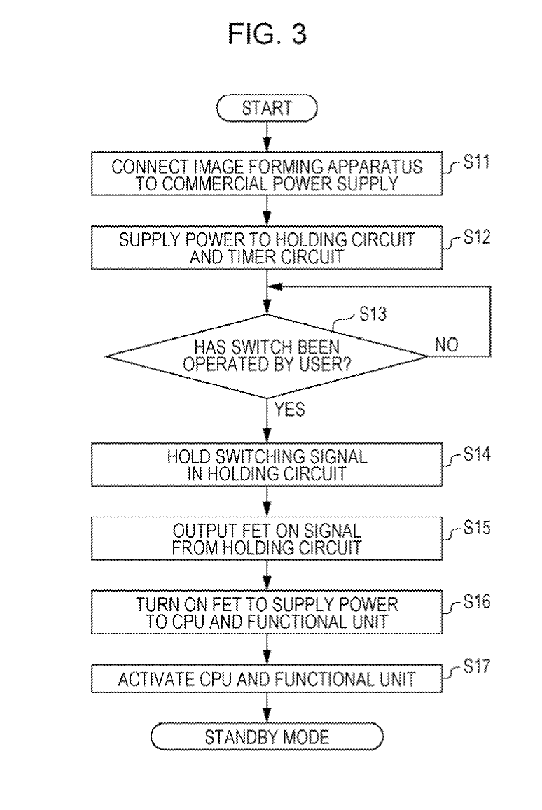

FIG. 3 is a flowchart illustrating an example of the procedure of power supply employed when the power plug of the image forming apparatus 100 is inserted in (connected to) the outlet supplied with the commercial power supply.

The power plug of the image forming apparatus 100 is inserted in (connected to) the outlet supplied with the commercial power supply (step 11, which is described as S11 in FIG. 3; the same applies to the subsequent steps).

Thereby, power is supplied to the holding circuit 22 of the power supply switching unit 20 and the timer circuit 41 of the switch detecting unit 40, as illustrated in FIG. 2 (step 12). Herein, the holding circuit 22 outputs the FET off signal to the FET. Accordingly, the FET is turned off, and the power is not supplied to the CPU of the controller 50 and the functional unit 60.

If the switch 31 is operated (held down) by the user (YES at step 13), the switching signal shifts from the “H” level to the “L” level. Then, the switching signal is transmitted to the holding circuit 22 as the power on signal on the signal line not routing through (detouring around) the timer circuit 41 of the switch detecting unit 40.

Then, the holding circuit 22 holds (stores) that the switching signal has shifted from the “H” level to the “L” level (step 14), and outputs the FET on signal to the FET (step 15). The holding circuit 22 continues to output the FET on signal to the FET even if the user stops holding down the switch 31 and the switching signal returns to the “H” level from the “L” level. That is, the holding circuit 22 has a function of holding (storing) that the switching signal has shifted from the “H” level to the “L” level (a latching function).

As the FET turns on, the power is supplied to the CPU of the controller 50 and the functional unit 60 (step 16). Thereby, the CPU of the controller 50 and the functional unit 60 are activated (step 17). Then, the image forming apparatus 100 shifts to the prepared state (standby state), in which functions such as image formation are executable, that is, the standby mode.

As described above, if the power plug of the image forming apparatus 100 is inserted in the outlet supplied with the commercial power supply and the switch 31 is operated (held down) by the user at step 13 (YES), the holding circuit 22 holds (stores) that the switch 31 has been operated, and continues to output the FET on signal.

If the switch 31 is not operated (held down) by the user at step 13 (NO), the holding circuit 22 holds (stores) that the switch 31 has not been operated, and continues to output the FET off signal. The holding circuit 22 holds the switching signal also in this case. That is, the holding circuit 22 has a function of holding the presence or absence of the operation of the switch 31.

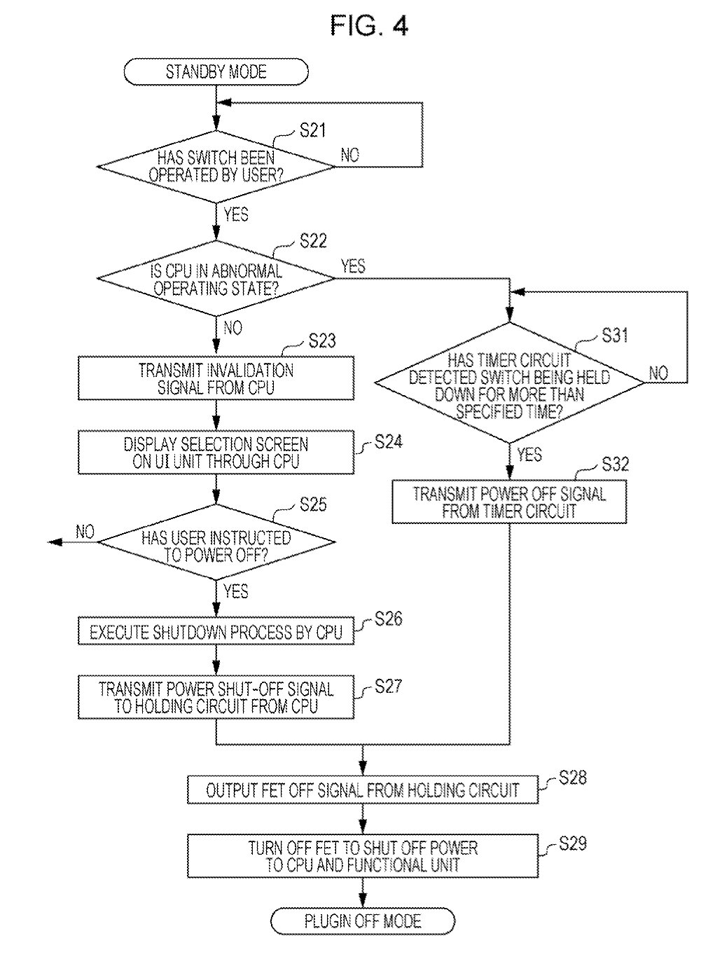

With reference to FIGS. 2 and 4, a description will now be given of a procedure of power supply employed when the switch 31 is operated (held down) by the user in the standby mode.

FIG. 4 is a flowchart illustrating an example of the procedure of power supply employed when the switch 31 is operated (held down) by the user in the standby mode.

Since the image forming apparatus 100 is in the standby mode, the holding circuit 22 continues to output the FET on signal to the FET. Thereby, the power is supplied to the CPU of the controller 50.

If the switch 31 is operated (held down) by the user (step 21), the switching signal shifts from the “H” level to the “L” level. Then, the switching signal shifted to the “L” level is transmitted to the timer circuit 41, the holding circuit 22, and the CPU, as illustrated in FIG. 2.

Upon receipt of the switching signal shifted from the “H” level to the “L” level, the timer circuit 41 starts measuring the time (counting).

The holding circuit 22 has already been outputting the FET on signal. Even if the holding circuit 22 receives the switching signal shifted from the “H” level to the “L” level (the power on signal), therefore, the switching signal does not function as the power on signal.

The procedure then branches depending on whether the CPU is in a normal operating state or in an abnormal operating state, such as a stopped state or a hang-up state (step 22).

If the CPU is not in the abnormal operating state but in the normal operating state at this step (NO at step 22), the CPU receives the switching signal shifted from the “H” level to the “L” level and transmits the invalidation signal to the holding circuit 22, as illustrated in FIG. 2 (step 23).

The invalidation signal refers to a signal that invalidates the power off signal (the emergency power off signal) transmitted to the holding circuit 22 by the timer circuit 41.

Then, the CPU displays on the display screen of the UI unit 61 of the functional unit 60 a selection screen for allowing the user to select a process to be executed next (step 24). The selection screen includes at least an option of whether or not to shift to the power shut-off (power-off) state (instruct to power off). The selection screen may also include another option, such as an option of whether or not to shift to the energy saving mode, for example.

The CPU then determines whether or not the user has instructed to power off (step 25). If a negative determination (NO) is made at step 25, that is, if an instruction for another option has been issued, the process set for the another option is executed. Description of the process set for the another option will be omitted here.

Meanwhile, if a positive determination (YES) is made at step 25, that is, if the user has instructed to power off, the CPU executes the shutdown process (step 26).

After the execution of the shutdown process, the CPU then transmits the power shut-off signal to the holding circuit 22 (step 27). Then, the holding circuit 22 outputs the FET off signal to the FET (step 28). Thereby, the FET is turned off, and the power supply to the CPU of the controller 50 and the functional unit 60 is shut off (step 29).

As described above, if the CPU is in the normal operating state at step 22 (NO), the CPU receives the switching signal shifted from the “H” level to the “L” level in accordance with the operation (holding down) of the switch 31 by the user, and executes the display of the selection screen and the shutdown process. That is, the image forming apparatus 100 is normally stopped by the predetermined shutdown process. Thereafter, the power supply to the CPU and the functional unit 60 is shut off.

As described later, the timer circuit 41 may transmit the power off signal (emergency power off signal) to the holding circuit 22 while the CPU is executing the shutdown process or the like. However, the CPU is transmitting to the holding circuit 22 the invalidation signal that invalidates the power off signal (emergency power off signal) transmitted from the timer circuit 41. Accordingly, the holding circuit 22 is prevented from outputting the FET off signal.

Meanwhile, if the CPU is in the abnormal operating state at step 22 (YES), the timer circuit 41 counts the period in which the switching signal is at the “L” level, and determines whether or not the period of the “L” level has continued for more than a predetermined time (specified time) (step 31). That is, the time in which the switch 31 is held down by the user is measured.

If a positive determination (YES) is made at step 31, that is, if the period counted by the timer circuit 41 exceeds the specified time, the timer circuit 41 transmits the power off signal (emergency power off signal) to the holding circuit 22. The CPU is in the abnormal operating state in this case, and thus does not transmit the invalidation signal that invalidates the power off signal (emergency power off signal) transmitted from the timer circuit 41.

Upon receipt of the power off signal (emergency power off signal) from the timer circuit 41, therefore, the holding circuit 22 outputs the FET off signal to the FET (step 28). Thereby, the FET is turned off, and the power supply to the CPU of the controller 50 and the functional unit 60 is shut off (step 29). Then, the image forming apparatus 100 shifts to the plugin off mode.

As described above, the holding circuit 22 of the power supply switching circuit 20 holds (stores) the signal corresponding to the operation (holding down) of the simple momentary switch 31, and holds the power control signal (FET on/off signal).

If the CPU of the controller 50 is in the normal operating state, the CPU transmits the invalidation signal that invalidates the power off signal transmitted by the timer circuit 41, even if the switch 31 is operated (held down). Therefore, immediate (urgent) shut-off of the power is suppressed, and the power is shut off after the shutdown process. This configuration suppresses shut-off of the power without holding setting values, and thus obviates the need to reset the setting values after restart. Further, the immediate (urgent) shut-off of the power supply may result in data corruption, for example, in the worst case owing to crash of a hard disk drive (HDD) or the like. In the normal operating state of the CPU of the controller 50, however, the immediate (urgent) shut-off of the power is suppressed even if the switch 31 is operated (held down), and the crash of the HDD or the like is suppressed. That is, the immediate (urgent) shut-off of the power is suppressed even if the switch 31 is accidentally operated (held down).

Further, the CPU displays the selection screen on the display screen of the UI unit 61 in accordance with the operation (holding down) of the switch 31 by the user, thereby allowing the user to easily select the desired shut-off (stopped) state.

Meanwhile, if the CPU of the controller 50 is in the abnormal operating state, the power supply to the CPU of the controller 50 and the functional unit 60 is shut off by the operation of the switch 31 (holding down of the switch 31 for more than the specified time). In this case, the immediate (urgent) shut-off of the power is given priority.

In FIG. 4, it is necessary to maintain the state in which the switch 31 is held down for more than the specified time (the period of the “L” level). This is for suppressing the shut-off of the power due to an unintended operation of the switch 31 by the user, such as light touch on the switch 31. Therefore, the specified time may be a short time, unlike the time of holding down the switch 31 necessary for a so-called emergency power-off operation. If the operation of the CPU is normal, the CPU transmits the invalidation signal. Therefore, the urgent shut-off of the power is suppressed even if the specified time is a short time.

In other words, it suffices if the specified time is set to be longer than the time taken for the CPU in the normal operating state to transmit the invalidation signal. If the specified time is shorter than the time taken for the CPU in the normal operating state to transmit the invalidation signal, the timer circuit 41 transmits the power off signal (emergency power off signal) to the holding circuit 22 before the CPU transmits the invalidation signal to the holding circuit 22, and the holding circuit 22 transmits the FET off signal to the FET, thereby causing the shut-off of the power. That is, the power is forcibly shut off without execution of the shutdown process and so forth despite the normal operating state of the CPU.

Therefore, the timer circuit 41 of the switch detecting unit 40 may be a delay line having a delay time set to be longer than the period taken for the CPU in the normal operating state to transmit the invalidation signal. Further, the specified time may not be provided if the CPU in the normal operating state immediately transmits the invalidation signal.

As described above, in the image forming apparatus 100 of the exemplary embodiment, the power supply of the image forming apparatus 100 is easily controlled with the single simple momentary switch 31, without a power switch for interrupting the commercial power supply. Accordingly, the cost of the image forming apparatus 100 is reduced.

In the foregoing exemplary embodiment, the CPU is supplied with power from the power supply switching circuit 21. However, the CPU may be supplied with power from the power supply circuit 11 not via the power supply switching circuit 21, like the holding circuit 22 and the timer circuit 41. In this case, the CPU is supplied with power also in the plugin off mode, and thus more power is consumed than in the case described in the exemplary embodiment.

### SECOND EXAMPLE

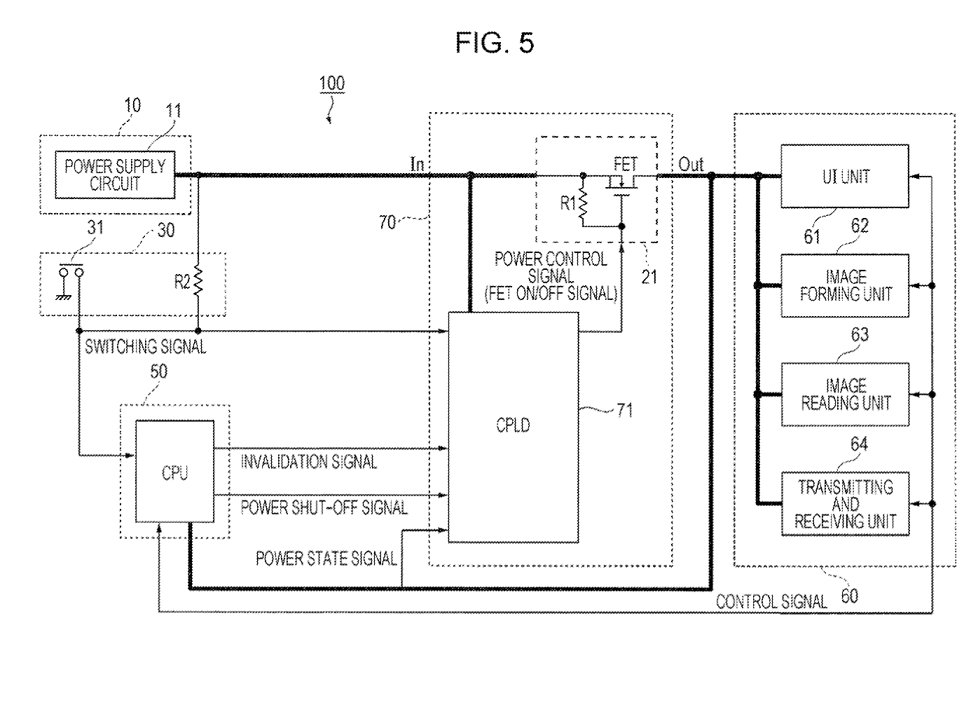

In a second example, some of the circuits of the first example are configured of an integrated circuit. FIG. 5 is a diagram illustrating another specific example (second example) of the image forming apparatus 100 illustrated in FIG. 1.

Herein, the timer circuit 41 of the switch detecting unit 40 and the holding circuit 22 of the power supply switching unit 20 in the first example illustrated in FIG. 2 are configured of a complex programmable logic device (CPLD) 71, which is a type of programmable logic device. Further, the power supply switching circuit 21 and the CPLD 71 form a power supply switching unit 70.

The CPLD may be replaced by a programmable array logic (PAL), which is another type of programmable logic device, a field-programmable gate array (FPGA), or an application specific integrated circuit (ASIC).

The second example is similar to the first example in the other configurations and operations, and thus description thereof will be omitted.

### MODIFIED EXAMPLE

In the foregoing first example, the CPU of the controller 50 transmits the invalidation signal to the holding circuit 22 of the power supply switching unit 20 to invalidate the power off signal (emergency power off signal) transmitted from the timer circuit 41 of the switch detecting unit 40.

Meanwhile, the CPU of the controller 50 may transmit a timer resetting signal to the timer circuit 41 of the switch detecting unit 40 to prevent the transmission of the power off signal (emergency power off signal).

A modified example of the first example will be described here.

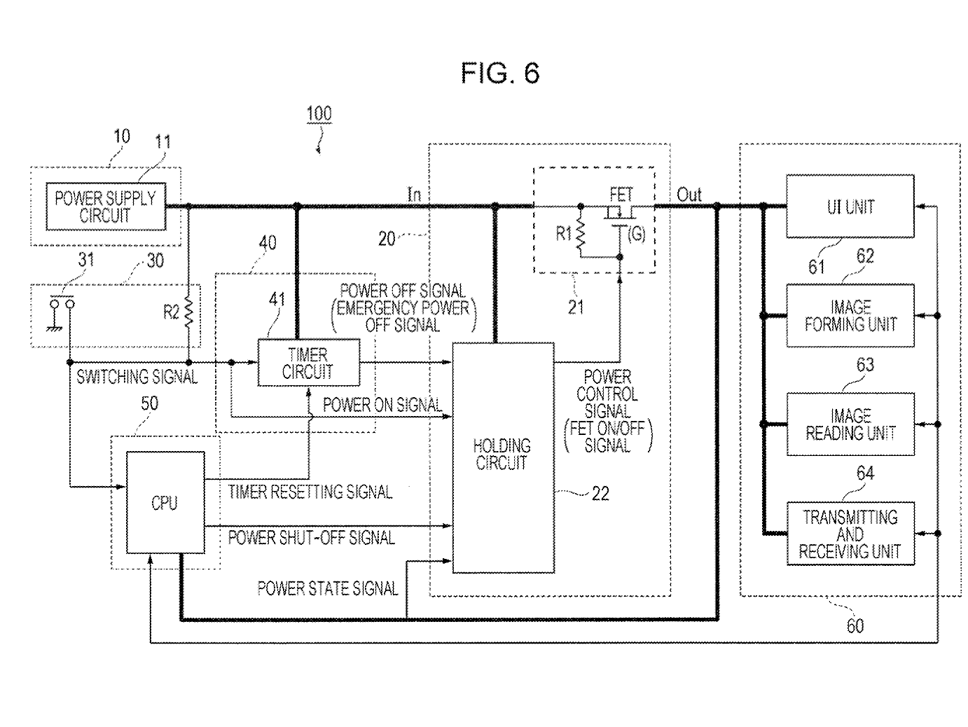

FIG. 6 is a diagram illustrating a modified example of the image forming apparatus 100 illustrated in FIG. 2.

In the modified example, the CPU transmits the timer resetting signal to the timer circuit 41. To prevent the count of the timer circuit 41 from reaching the specified time, the CPU transmits the timer resetting signal to the timer circuit 41 before the count of (the time measured by) the timer circuit 41 reaches the specified time.

Thereby, the count of (the time measured by) the timer circuit 41 is reset, and the power off signal (emergency power off signal) is prevented from being transmitted from the timer circuit 41 of the switch detecting unit 40 to the power supply switching unit 20.

The modified example is similar to the first example in the other configurations and operations, and thus description thereof will be omitted.

Although not illustrated, the modified example has a configuration that transmits the timer resetting signal from the controller 50 to the switch detecting unit 40 in place of the invalidation signal in FIG. 1.

Further, the timer circuit 41 of the switch detecting unit 40 and the holding circuit 22 of the power supply switching unit 20 may be configured of a complex programmable logic device (CPLD) as a type of programmable logic device, similarly to the second example.

Although the description has been given above of the image forming apparatus 100 in the exemplary embodiment, the functional unit 60 may include another functional unit as a load in place of the image forming unit 62, for example. In this case, the controller 50 of the power supply device may be used for the control of the another functional unit as well as the control of the power supply switching unit 20 (the power supply switching unit 70).

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image forming unit that forms an image;
a power supply switching unit that switches the image forming unit between a power supplied state and a power shut-off state;
a switching unit that outputs a signal when operated by a user;
a switch detecting unit that detects the signal output by the switching unit and transmits a power off signal to the power supply switching unit; and
a controller that receives the signal output by the switching unit, and if normally operating, transmits a signal that invalidates the power off signal or a signal that prevents the transmission of the power off signal.

2. The image forming apparatus according to claim 1, wherein the power supply switching unit switches the controller between a power supplied state and a power shut-off state.

3. A power supply device comprising:
a power supply switching unit that switches a load connected to the power supply device between a power supplied state and a power shut-off state;
a switching unit that outputs a signal when operated by a user;
a switch detecting unit that detects the signal output by the switching unit and transmits a power off signal to the power supply switching unit; and
a controller that receives the signal output by the switching unit, and if normally operating, transmits a signal that invalidates the power off signal or a signal that prevents the transmission of the power off signal.

4. The power supply device according to claim 3, wherein the power supply switching unit switches the controller between a power supplied state and a power shut-off state.

5. The power supply device according to claim 3, wherein the switch detecting unit includes a timing circuit that starts measuring a time upon detection of the signal, and
wherein, when the time started to be measured exceeds a predetermined specified time, the timing circuit transmits the power off signal to the power supply switching unit.

6. The power supply device according to claim 4, wherein the switch detecting unit includes a timing circuit that starts measuring a time upon detection of the signal, and
wherein, when the time started to be measured exceeds a predetermined specified time, the timing circuit transmits the power off signal to the power supply switching unit.

7. The power supply device according to claim 5, wherein the controller transmits to the power supply switching unit the signal that invalidates the power off signal.

8. The power supply device according to claim 6, wherein the controller transmits to the power supply switching unit the signal that invalidates the power off signal.

9. The power supply device according to claim 5, wherein the controller transmits to the timing circuit the signal that prevents the transmission of the power off signal.

10. The power supply device according to claim 6, wherein the controller transmits to the timing circuit the signal that prevents the transmission of the power off signal.

11. An image forming method comprising:
causing an image forming unit to form an image;
switching the image forming unit between a power supplied state and a power shut-off state;
outputting a signal in response to an operation performed by a user;
detecting the output signal and transmitting a power off signal; and
causing a controller to receive the output signal, and if the controller is normally operating, transmit a signal that invalidates the power off signal or a signal that prevents the transmission of the power off signal.
